(19) United States
(12) Patent Application Publication
(10) Pub. No.: US 2008/0290986 A1
(43) Pub. Date: Nov. 27, 2008

(54) Method and system for mobile wireless shut-off of utility service

(75) Inventors: Kelly Laughlin-Parker, Waukesha, WI (US); Brian E. Brandt, West Bend, WI (US); Chris Niemuth, Grafton, WI (US)

Correspondence Address: BOYLE FREDRICKSON S.C., 840 North Plankinton Avenue, MILWAUKEE, WI, 53203, US

(73) Assignee: Badger Meter, Inc.

(21) Appl. No.: 11/804,948

(22) Filed: May 21, 2007

(51) Int. Cl. G05B 23/00; F16K 31/02

(52) U.S. Cl. 340/3.8

(57) ABSTRACT

A method and system for transmitting signals to control a utility service from a drive-by or walk-by control unit includes an electronically controlled shut-off valve in a supply line for the utility service. The shut-off valve has a solenoid that communicates electronically with a meter transceiver used by a metering device. A transmitter is included in the walk-by or drive-by control unit and sends a signal to the wireless transceiver to operate the solenoid to close the valve or to open the valve. After this action occurs, the meter transceiver will send an acknowledge signal to the control unit to confirm that the shut-off valve has been opened or closed.

### TECHNICAL FIELD

This invention relates to utility metering equipment for a utility such as water, gas or electricity.

### DESCRIPTION OF THE BACKGROUND ART

Lilly et al., U.S. Pat. Pub. No. US2005/0236594, discloses a valve controlled by a stationary pushbutton switch and a transmitter for sending radio signals to the valve to shut off a utility supply system in a building. This system is designed for operation by occupants of the building.

Sanders, U.S. Pat. No. 6,892,751, shows and describes a building protection system with a wireless switch that is used to close or open a shut-off valve to control the flow of the utility into the building. This is also in the context of building control system.

Fernandez-Sein, U.S. Pat. No. 6,994,309, discloses transmitting a signal through a fixed radio network to operate a gas valve controlling the flow of gas.

Cerny et al., U.S. Pat. No. 5,298,894, discloses a mobile automatic meter reading (AMR) system in which a utility meter transmitter receives metering signals from a transducer installed on a utility meter and transmits radio frequency (RF) meter data signals to an RF collection unit in a drive-by vehicle. In these mobile AMR systems, a vehicle or a person on foot with an RF data collection unit can move through a neighborhood and collect a large number of readings per hour without entering the property of the customers.

There are various reasons for shutting off utility service such as to protect the utility system or property in an emergency response situation, or in some cases to deal with customers who have not paid their utility bills over some time period.

In the latter case, shut-offs are regulated by state and local regulatory bodies, and it is preferable that the utilities, or their agents, as opposed to occupants of a building, have control of the shut-off of utility service.

It is also sometimes necessary to start up service from a shut-off condition.

### SUMMARY OF THE INVENTION

The invention provides a method and circuitry for transmitting signals to operate a shut-off valve controlling a utility service from a mobile radio signaling unit.

In a water utility embodiment, the method and apparatus involve an electronically controlled shut-off valve. The shut-off valve has a solenoid that receives signals from a meter transceiver used by a metering device to transmit meter consumption signals.

A mobile radio signaling unit sends a signal to the wireless transceiver to operate the solenoid to close the shut-off valve or to open the shut-off valve. After this action occurs, the meter transceiver then sends an acknowledge signal to the mobile radio signaling unit to confirm that the shut-off valve has been opened or closed. This is particularly significant, as the operator of the mobile unit requires some feedback that the action has been accomplished, since the valve is not visible to the operator.

The shut-off valve is installed in a supply line, conveniently near the installation of a metering device, and the two units can be connected in parallel to the transceiver. Thus, one transceiver can be used to transmit meter consumption signals back to the radio signaling unit as well as to handle control signals to the shut-off valve.

The invention is very advantageous over fixed shut-off switches for a number of reasons including control over many shut-off valves with one unit and security of the control unit.

Preferably, the mobile radio signaling unit is carried by a vehicle or is a carried by a person covering a route for meter data collection.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a perspective view of an AMR system with two types of mobile transceivers for wireless communication with a transceiver with a water meter;

FIG. 2 is an enlarged view of a pit enclosure seen in FIG. 1 with equipment for carrying out the invention installed in the pit enclosure; and

FIG. 3 is an electronic block diagram of a transceiver mounted in a housing in the pit enclosure.

### DETAILED DESCRIPTION OF THE PREFERRED EMBODIMENTS

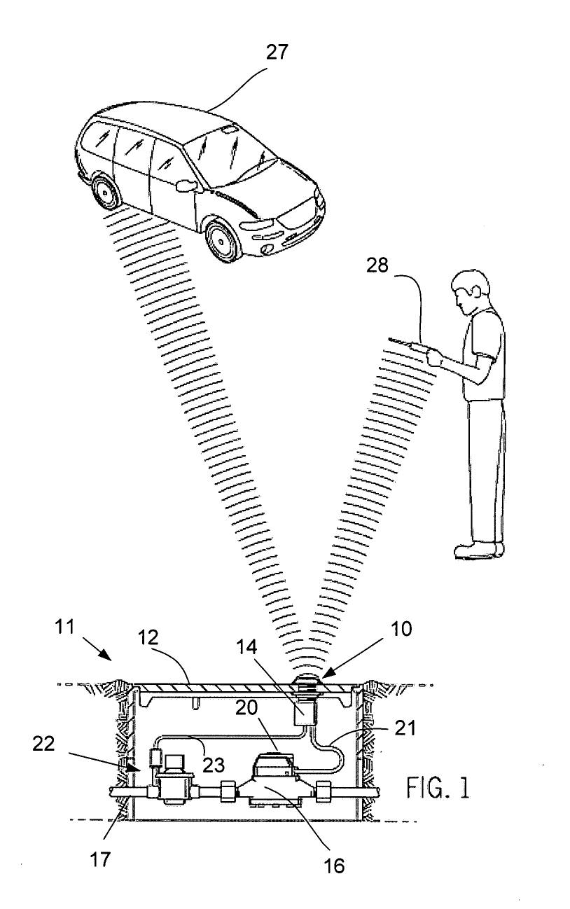

Referring to FIG. 1, in one example of the invention, a utility meter, in this case a water meter 16, is connected in a water supply line 17 in a subsurface pit enclosure 11. The water meter 16 could also be connected in a water supply line within a building, but in warmer climates, where basements may or may not be available, it is the practice to mount water meter equipment in a subsurface pit enclosure 11 in a yard or other available area.

The pit is typically made of metal, concrete, plastic or other materials and has a lid 12 which is removable to open the enclosure 11 for access. The pit enclosure 11 is located along the route of water supply pipe 17. The water meter housing 16 is connected in the water supply line 17. A water meter register unit 20 is mounted on top of the water meter housing 16. As known in the art, meter registers convert mechanical movements of a meter to visual and numerical representations of consumption often shown in an odometer type read-out device. The register 20 is preferably a unit that is commercially distributed by Badger Meter, Inc., the assignee of the present invention, under the trade designation “Recordall” Transmitter Register (RTR). Besides displaying units of consumption, this device 20 uses a transducer that is described in Strobel et al., U.S. Pat. No. 4,868,566, entitled “Flexible Piezoelectric Switch Activated Metering Pulse Generators,” to convert the mechanical movements of the meter to electrical signals. Other metering transducers known in the art and using optics and an absolute digital encoder (ADE) circuit can also be used as the register 20.

The register 20 connects via a shielded cable 21 to a transceiver 10, which is housed in a tubular housing 14 of plastic material that hangs down from the pit lid 12. The electrical signals from the register 20 are sent to the transceiver 10, for transmission through a radio network. Besides the cable 21, it is also known in the art to communicate these signals wirelessly in the pit between the meter register 16 and the meter transceiver 10.

The transceiver 10 communicates via RF signals with a mobile receiver which can be a radio receiver in a vehicle 27 or with a handheld receiver 28 carried by a service technician. These receivers are carried along a route for collection of utility metering data. The mobile receiver in the vehicle 28 can be an Orion® receiver 15, adapted in this case for providing transmissions with limited command signals as well as receiving RF signals with meter data. This Orion® receiver is commercially offered by the assignee of the present invention. Besides signaling radio frequency (RF) signals, this device also receives meter data, and certain status data of a type known in the art. This meter data and status data can then be transferred to a laptop computer also located in the vehicle 27. The receiver may use an antenna (not shown) mounted on a roof of the vehicle 27. In the case of the handheld device 28, this is carried back to a site where the device 28 is placed in a pedestal including an electrical connector and the meter data is unloaded to a personal computer. For both types of radio collection units, the transceiver 10 transmits an electronic message that includes at least an identification code, meter reading data, and an error code for checking the data at the receiving end. In addition other types of status data, such as tamper indication data, can be included in the message. The utility consumption data is collected from meters at various customer locations for billing purposes.

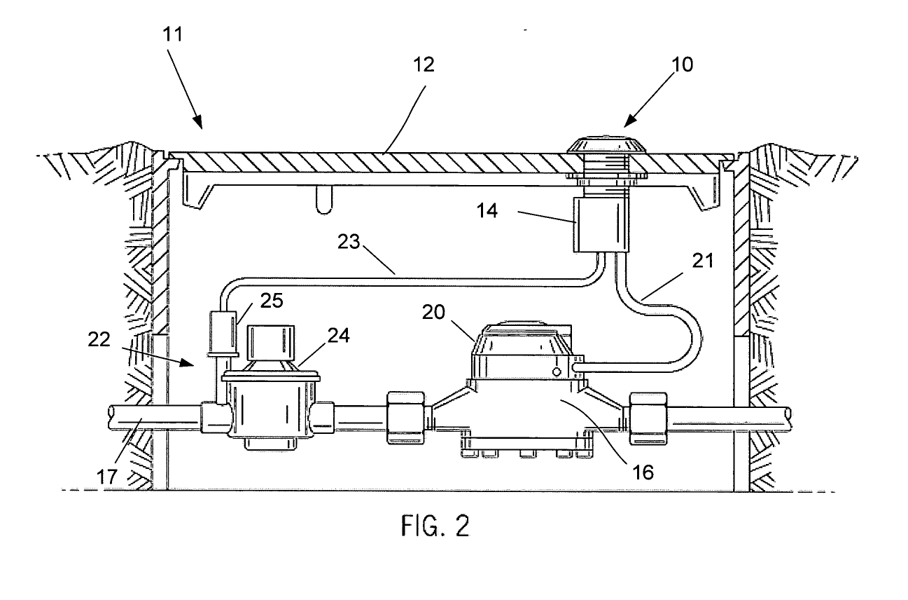

In the present invention, a solenoid-operated valve assembly 22 is installed in the supply line 17 in front of the meter 16 to open and close a shut-off valve in response to signals from the meter transceiver 10. The valve assembly 22 is connected to the meter transceiver 10 by wires 23 but could also communicate these signals wirelessly within the pit enclosure 11. As seen in FIG. 2, the valve assembly 22 includes a valve 24 and an electrically operable actuator 25 for opening and closing the shut-off valve in response to electrical signals.

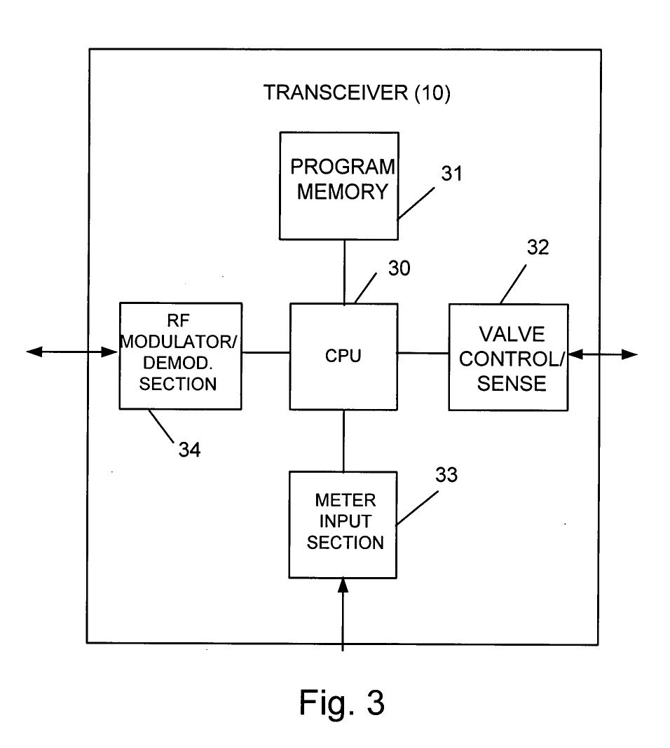

Referring to FIG. 3, the meter transceiver 10 also includes an electrical circuit typically formed on a circuit board and including a microelectronic central processor unit (CPU) 30 operating according to a control program stored in a program memory 31, which in this case is a flash memory or other type of non-volatile memory. The CPU 30 is electrically connected to valve control/sense section 32 to send signals to operate the valve assembly 22 as well as to sense the current status of the valve as open or closed. As further seen in FIG. 3, the CPU 30 receives signals from a meter transducer (not shown) through a meter input section 33. This input section can receive a pulse input or an input from an absolute digital encoder (ADE) circuit of a type known in the art. It then transmits metering data in a message protocol, which is converted to radio frequency (RF) signals by an RF modulator/demodulator section 34. This section 34 converts between RF signals communicated to and from the mobile radio signaling units 27, 28 and data signals processed internally by the CPU 30.

Through the RF section 34, the transceiver 10 can both receive and transmit RF signals in a wireless network. The transceiver 10 will normally be in a sleep mode from which it will periodically wake-up and send a message on a single frequency within the 902-928 Mhz frequency band and in accordance with FCC regulations. The power level of the transmission is limited by FCC regulations. An Orion® transceiver in a drive-by vehicle 27 or a handheld transceiver 28 will be able to read the transmitter signal and collect meter reading data.

It is also possible to provide a second type of transmission utilizing a higher power level. This is accomplished by periodically sending out a higher power signal according to a frequency-hopping spread-spectrum mode of operation, which is the subject of different FCC regulations permitting a higher power level.

In either mode of transmission, the transceiver 10 is electrically connected to the electrically operable actuator 24 to open or close the shut-off valve 25 in response to receiving wireless control signals from the walk-by handheld unit 28 an RF control unit having a radio transceiver in a drive-by vehicle 27. The control signals can include either an OFF signal to shut-off service, or an ON signal to initiate or restore service.

When the CPU 30 in the transceiver 10 senses the open or closed condition of the valve assembly 22, it transmits an acknowledge signal to the walk-by or drive-by radio signaling unit in response to the opening or closing of the shut-off valve to confirm that the operation has been carried out.

The invention is very advantageous over fixed shut-off switches for a number of reasons including control over many shut-off valves with one unit and security of the control unit.

This has been a description of the preferred embodiments, but it will be apparent to those of ordinary skill in the art that variations may be made in the details of these specific embodiments without departing from the scope and spirit of the present invention, and that such variations are intended to be encompassed by the following claims.

We claim:

1. A system for mobile wireless shut-off of a utility service, the system comprising:
a valve for connection in a supply line supplying the utility service, the valve being connected in advance of a utility metering device;
the valve including an electrically operable actuator for opening and closing the valve in response to electrical signals; and
a transceiver electrically communicating with the electrically operable actuator to open or close the valve in response to receiving wireless control signals from a mobile radio signaling unit.

2. The system as recited in claim 1, wherein the transceiver also receives command signals and transmits electrical metering signals from the utility metering device.

3. The system as recited in claim 2, wherein the valve, the transceiver and the utility metering device are located in a subsurface pit enclosure.

4. The system of claim 2, wherein the utility is water.

5. The system of claim 1, wherein the mobile radio signaling unit is carried by a vehicle or is a carried by a person covering a route for meter data collection.

6. The system of claim 1, wherein the transceiver is part of an assembly that includes a processor, and wherein the processor senses a on or off condition of the valve and transmits an acknowledge signal to the mobile radio signaling unit in response to the opening or closing of the valve.

7. The system as recited in claim 1, wherein the transceiver further comprises:
a CPU operating according a stored control program; and
a radio frequency modulation and demodulation section for transmitting and receiving radio frequency signals and for communicating data and control signals with the CPU.

8. The system as recited in claim 1, wherein the transceiver operates in a frequency range between 902 Mhz and 928 Mhz.

9. The system as recited in claim 1, wherein the transceiver operates through transmission of frequency hopping spread spectrum signals.

10. A method of controlling an on or off condition of a utility service, the method comprising:
using a shut-off valve in a supply line supplying the utility service, the valve being connected in advance of a utility metering device;
providing the valve with an electrically operable actuator for opening and closing the shut-off valve in response to electrical signals;
using a meter transceiver to communicate electronically with the electrically operable actuator to open or close the shut-off valve in response to receiving wireless control signals; and
the meter transceiver receiving wireless control signals from a transceiver in a mobile radio signaling unit, and being responsive to such control signals, to send signals to the electrically operable actuator to open or close the shut-off valve.

11. The method of claim 10, wherein the meter transceiver receives command signals and transmits electrical metering signals from the utility metering device.

12. The method as recited in claim 11, wherein the valve, the transceiver and the utility metering device are located in a subsurface pit enclosure.

13. The method of claim 12, wherein the utility is water.

14. The method of claim 10, wherein the mobile radio signaling unit is carried by a vehicle or is a carried by a person covering a route for meter data collection.

15. The method of claim 10, further comprising transmitting an acknowledge signal to the mobile radio signaling unit in response to the opening or closing of the shut-off valve to confirm an open or closed condition of the shut-off valve.

16. The method as recited in claim 10, wherein the meter transceiver operates in a frequency range between 902 Mhz and 928 Mhz.

17. The method as recited in claim 10, wherein the meter transceiver operates through transmission of frequency hopping spread spectrum signals.
